(19) United States
(12) Patent Application Publication
(10) Pub. No.: US 2014/0262126 A1
(43) Pub. Date: Sep. 18, 2014

(54) COOLING APPARATUS AND COOLING METHOD

(71) Applicant: KABUSHIKI KAISHA TOSHIBA, Tokyo (JP)

(72) Inventors: Ena ISHII, Kanagawa-ken (JP); Mitsunobu YOSHIDA, Kanagawa-ken (JP)

(73) Assignee: KABUSHIKI KAISHA TOSHIBA, Tokyo (JP)

(21) Appl. No.: 14/192,603

(22) Filed: Feb. 27, 2014

(30) Foreign Application Priority Data
Mar. 15, 2013 (JP) 2013-053454

(51) Int. Cl. B60H 1/00

(52) U.S. Cl. CPC B60H 1/00492
USPC 165/10

(57) ABSTRACT

In one embodiment, a heat exchanger is provided at portion of a circulation circuit to provide heat from a heating element to a medium. A cooling unit is provided at portion of the circulation circuit to cool the medium. A heat storage tank is arranged between the heat exchanger and the cooling unit, and includes a phase change material. A bypass circuit bypasses the heat storage tank. A control valve is capable of switching a flow of the medium to one of the heat storage tank or the bypass circuit. A measurement unit measures a temperature of the phase change material. A determination unit uses the measured temperature and determines whether or not the phase change material is in a heat storable state. A control unit controls the control valve to switch the flow of the medium from the bypass circuit to the heat storage tank.

### CROSS-REFERENCE TO RELATED APPLICATION

This application is based upon and claims the benefit of priority from the prior Japanese Patent Application No. 2013-053454, filed on Mar. 15, 2013, the entire contents of which are incorporated herein by reference.

### FIELD

Embodiments described herein relate generally to cooling apparatus and method for cooling a heating element.

### BACKGROUND

A heating element such as a motor, a battery or an inverter is cooled by circulating a medium in a cooling apparatus. The cooling apparatus cools the heating element by giving heat to the medium. The medium gives the heat received from the heating element to a radiator provided at a portion of a flow path of the medium, and the heat is released to the air from a surface of the radiator. An electric fan is rotated to generate air flow to a radiator so as to facilitate release of heat from the radiator to obtain necessary cooling performance. Such a method of generating air flow to a radiator is generally used. However, such a cooling apparatus rotates an electric fan for a long time, resulting in increase of consumption amount of energy such as electric power.

### BRIEF DESCRIPTION OF THE DRAWINGS

FIG. 1 is a block diagram illustrating a cooling apparatus according to a first embodiment.

FIGS. 2A to 2D are views for explaining a heat storage state of a phase change material of the cooling apparatus.

FIG. 3 is a flowchart illustrating processing which is executed in a determination unit of the cooling apparatus.

FIG. 4 is a flowchart illustrating processing which is executed by a control unit of the cooling apparatus.

FIG. 5 is a flowchart illustrating processing which is executed by the control unit of the cooling apparatus.

FIG. 6 is a block diagram illustrating a cooling apparatus according to a second embodiment.

FIG. 7 is a flowchart illustrating processing in a determination unit of the cooling apparatus according to the second embodiment.

FIG. 8 is a flowchart illustrating processing which is executed by a control unit of the cooling apparatus according to the second embodiment.

FIG. 9 is a flowchart illustrating processing which is executed by the control unit of the cooling apparatus according to the second embodiment.

### DETAILED DESCRIPTION

According to one embodiment, a cooling apparatus is provided. The cooling apparatus includes a circulation circuit, a heat exchanger, a cooling unit, a heat storage tank, a bypass circuit, a control valve, a measurement unit, a determination unit and a control unit.

The circulation circuit is closed to circulate a medium in a direction. The heat exchanger is provided at portion of the circulation circuit to provide heat released from a heating element to the medium. The cooling unit is provided at portion of the circulation circuit to cool the medium. The heat storage tank is arranged at a portion of the circulation circuit and between the heat exchanger and the cooling unit. The heat storage tank includes a phase change material to receive heat from the medium flowing through the circulation circuit. The bypass circuit is connected to the circulation circuit at a first branch point between the heat exchanger and the heat storage tank and at a second branch point between the heat storage tank and the cooling unit. The control valve is capable of switching a flow of the medium to one of the heat storage tank or the bypass circuit. The measurement unit measures a temperature of the phase change material. The determination unit uses the measured temperature and determines whether or not the phase change material is in a heat storable state. The control unit controls the control valve to switch the flow of the medium from the bypass circuit to the heat storage tank while the phase change material is in the heat storable state.

Hereinafter, further embodiments will be described with reference to the drawings. In the drawings, the same reference numerals denote the same or similar portions respectively.

A first embodiment will be described with reference to FIG. 1. FIG. 1 is a block diagram illustrating a cooling apparatus according to a first embodiment.

A cooling apparatus 1000 is provided in an electric vehicle, for example. The electric vehicle has a motor, a battery, an inverter, an electronic control unit (ECU) for controlling these units, etc. The inverter inverts a power provided from the battery and supplies an inverted power to the motor. The motor, the battery or the inverter is a heating element 10, and the heating element 10 generates heat with operation of the vehicle. The cooling apparatus 1000 has a heat exchanger 15 provided near the heating element 10.

The heat exchanger 15 gives heat of the heating element 10 to a medium. The medium circulates in a circulation circuit 101 composing the cooling apparatus 1000. Heat received by the medium is released to an outside from a radiator 31. The radiator 31 is a cooling unit provided at portion of the circulation circuit 101. By repeatedly releasing heat in this manner, it is possible to cool the heating element 10 sufficiently.

In many cases, an electric fan 32 is also used as an unit of generating air flow to the radiator 31 for the purpose of increasing heat release effect of the radiator 31.

In the cooling apparatus 1000, a heat storage tank 20 having a phase change material 25 is further provided at a portion of the circulation circuit 101. It is possible to store heat of the medium circulating through the circulation circuit 101 in the phase change material 25. The phase change material 25 can be used as a cooling source for drawing heat from the medium. While the phase change material 25 is in a state where heat is not stored to an upper limit of capacity and can further store heat, the phase change material 25 draws heat from the medium and stores the heat.

Accordingly, it is not necessary to rotate the electric fan 32 for cooling the radiator 31 or it is sufficient to rotate the electric fan 32 at a low speed, while the phase change material 25 stores heat of the medium. As a result, the heating element 10 is cooled while suppressing consumption amount of energy or power. The cooling apparatus 1000 can reduce the consumption amount of energy or power, compared with a case where a phase change material is not used and only a radiator is used as a cooling source and where an electric fan is rotated for a long time.

When the temperature of the phase change material 25 exceeds a melting point due to heating, the phase change material 25 causes phase transition and becomes a liquid. While the temperature of the phase change material 25 further rises and exceeds the upper limit of capacity, cooling is performed by stopping storing heat in the phase change material 25, rotating the electric fan 32 and releasing heat of the medium from the radiator 31.

When the motor as the heating element 10 is turned off after heat is stored in the phase change material 25, heat from the heating element 10 is decreased or heat is not released from the heating element 10, and the temperature of the phase change material 25 lowers gradually. Then, the phase change material 25 enters into a state where the phase change material 25 does not cause phase transition even when the temperature of the phase change material 25 becomes a freezing point or less. The state is called a supercooled state. When the phase change material 25 is in a supercooled state, for example, when the motor is started to operate again after the motor is stopped for a while, it is possible to release heat of solidification (latent heat) at a time by stimulating the phase change material 25 using a nucleating device 150. The temperature of the phase change material 25 lowers by releasing the heat of solidification, and it becomes possible to store heat.

The circulation circuit 101 of FIG. 1 is a flow path in which a medium circulates for exchanging heat. The medium is a liquid or gas which can transport heat obtained by heat exchange. Water is used as the medium in the embodiment.

Further, the cooling apparatus 1000 has a first measurement unit 130, a second measurement unit 140, a bypass circuit 102, and a control valve 103. The first measurement unit 130 measures a temperature (first temperature) of the phase change material 25. The second measurement unit 140 measures a temperature (second temperature) of a medium which circulates in the circulation circuit 101. The bypass circuit 102 is connected to a portion of the circulation circuit 101 and bypasses the heat storage tank 20. The control valve 103 can switch a flow path of the medium which flows in the circulation circuit 101. Specifically, the control valve 103 switches flow paths of the circulation circuit 101 such that the medium flows passing through the heat storage tank 20 or the bypass circuit 102.

The cooling apparatus 1000 of FIG. 1 further has a control device 200 and a storage device 300. An arithmetic processing unit such as a CPU or a MPU is used as the control device 200. A recording medium such as a memory or a HDD is used as the storage device 300.

As described below, the control device 200 acquires necessary data such as a first temperature, a second temperature and a supercooled state from the first measurement unit 130, the second measurement unit 140 and the nucleating device 150 cyclically, and stores the data in the storage device 300, as described below. The control device 200 has a determination unit 41 and a control unit 42. The control device 200 controls the control valve 103 and the electric fan 32 using the data stored in the storage device 300.

Hereinafter, the cooling apparatus 1000 will be described in more detail.

In FIG. 1, the circulation circuit 101 is a pipe which connects the heat exchanger 15, the heat storage tank 20 and the radiator 31 annularly. The medium circulates in the pipe. Specifically, the circulation circuit 101 connects between the heat exchanger 15 and the heat storage tank 20, between the heat storage tank 20 and the radiator 31, and between the radiator 31 and the heat exchanger 15. The circulation circuit 101 can exchange heat between the medium and the heating element 10, and between the medium and the phase change material 25. The circulation circuit 101 is desirably made of a metal material such as copper having large thermal conductivity at a portion at which heat is exchanged. The medium passes through the heat exchanger 15, the heat storage tank 20, and the radiator 31 sequentially and circulates in the circulation circuit 101 while repeating exchanging heat with the heating element 10 and the phase change material 25. The medium is moved in the circulation circuit 101 by a pump (not illustrated), for example.

The phase change material 25 is made of a material which can cause phase transition between a solid phase and a liquid phase by heat exchange. The phase change material 25 can be in a supercooled state in the liquid phase. Further, the phase change material 25 is nucleated and causes phase transition to the solid phase, while an impact or a voltage is applied to the material in a supercooled state. The phase change material 25 releases latent heat with phase transition to the solid phase. In the embodiment, sodium acetate hydrate may be used for the phase change material 25.

When driving the electric vehicle, the heating element 10 gives heat generated by operation of the electric vehicle to the medium which circulates in the circulation circuit 101 through the heat exchanger 15.

When the heating element 10 is a motor and has a water jacket which penetrates the inside of the motor, the water jacket can be connected to the circulation circuit 101. By the connection of the water jacket, heat from the heating element 10 is given to the medium by heat exchange when the medium passes in the water jacket.

The heat storage tank 20 is a container provided in a downstream of the heat exchanger 15 of the circulation circuit 101. The heat storage tank 20 contains the phase change material 25. The “downstream” or an “upstream” is defined based on a direction in the circulation circuit 101 in which the medium flows. The heat storage tank 20 connects a tube (not illustrated) which penetrates the inside of the container to the circulation circuit 101. While the control valve 103 is “ON”, the medium which has exchanged heat with the heating element 10 passes in the tube of the heat storage rank 20. In this case, the phase change material 25 receives heat of the medium by heat exchange.

As described above, the heat storage tank 20 contains the nucleating device 150 which nucleates the phase change material 25 in the supercooled state. The nucleating device 150 is controlled by the control unit 42 described below. The nucleating device 150 is turned on to add a trigger such as an impact or a voltage to the phase change material 25 in a supercooled state. As a result, the supercooled state of the phase change material 25 is ended, and phase transition to the solid phase is caused. At this time, the phase change material 15 releases latent heat.

The first measurement unit 130 is a temperature sensor provided inside the heat storage tank 20. The first measurement unit 130 measures a first temperature of the phase change material 25 in the heat storage tank 20. The second measurement unit 140 is a temperature sensor provided between the heat exchanger 15 and the heat storage tank 20. The second measurement unit 140 measures a second temperature of the medium which passes between the heat exchanger 15 and the heat storage tank 20. In the present embodiment, the second temperature is the temperature of the medium which has a high temperature after heat is received by heat exchange with the heating element 10. The first temperature is cyclically measured by the first measurement unit 130 and the second temperature is cyclically measured by the second measurement unit 140. The first and second temperatures measured cyclically can be stored in the storage device 300 as a temperature time history. The second measurement unit 140 may be provided between the radiator 31 and the heat exchanger 15.

The bypass circuit 102 bypasses the flow path of the medium from a first branch point A in the upstream of the heat storage tank 20 to a second branch point B in the downstream, while the control valve 103 is “OFF”.

The radiator 31 receives heat from the medium which passes the inside of the radiator 31, and cools the medium by releasing heat from the surface of the radiator 31 to the outside of the radiator 31 by heat transfer. The radiator 31 is desirably provided in a direction in which a driver faces when the driver sits on a driver's seat of the electric vehicle, in order to facilitate release of heat. Specifically, the radiator 31 may be at a place at which an air flow or wind produced when the electric vehicle runs is received. The place is a front of the electric vehicle, for example. Further, it is desirable to provide a plurality of heat releasing fins (not illustrated) on the surface of the radiator 31 to increase a surface area substantially.

The electric fan 32 rotates to generate an air flow toward the radiator 31 and cools the radiator 31. The control unit 42 controls the electric fan 32 to switch “ON (rotation)”/“OFF (stop)” of the electric fan 32 and further to change the number of times of rotation, so as to adjust an air volume of the air flow which is received by the radiator 31. The surface temperature of the radiator 31 is cooled, and the temperature of the medium which passes inside the radiator 31 is cooled by adjusting the air volume of the air flow.

The control device 200 of FIG. 1 has the determination unit 41 and the control unit 42 as logic modules of the arithmetic processing unit. The determination unit 41 determines a heat storage state of the phase change material 25. The control unit 42 determines a control mode for cooling the heating element 10, and controls the electric fan 32, the control valve 103, the nucleating device 150 etc. according to the determined control mode.

In the present embodiment, the heat storage state of the phase change material 25 which is determined by the determination unit 41 includes a “heat storable state” and “heat fully-stored state”. The “heat storable state” refers to a state where the heat storage amount of the phase change material 25 does not reach an upper limit of capacity, i.e., a state where heat can be stored as latent heat. The “heat fully-stored state” refers to a state where the heat storage amount reaches the upper limit of capacity. Further, the state of the phase change material 25 includes a “supercooled state” and a “non-supercooled state”. In the “supercooled state”, even when the temperature of the phase change material 25 is lower than the melting point, a state of liquid phase is maintained. In the “non-supercooled state”, while the temperature of the phase change material 25 is lower than the melting point, the phase change material 25 is in a state of solid phase.

The cooling apparatus 1000 sets the control unit 42 to a “first control mode,” while the first temperature of the phase change material 25 rises by heating the heat element 10, for example. In the “first control mode”, while the phase change material 25 is capable of storing heat, heat of the medium is stored in the phase change material 25. Further, while heat is stored in the phase change material 25 to the upper limit of the heat storage amount of the phase change material 25, the electric fan 32 is rotated to release heat of the medium from the radiator 31.

The cooling apparatus 1000 sets the control unit 42 to a “second control mode,” while the first temperature of the phase change material 25 is maintained at a constant value or decreased at a time point when the heating element 10 starts to generate heat, for example. In the “second control mode,” while the phase change material 25 is in a supercooled state, the nucleating device 150 nucleates the phase change material 25 and releases heat of solidification (latent heat) to the outside.

FIGS. 2A to 2D are views for explaining a heat storage state of the phase change material 25. In FIGS. 2A to 2D, the heating element 10 starts to operate at a time T0, and the heating element 10 stops operating at a time T3.

FIG. 2A illustrates an example of a change of an absolute temperature (° K) of the phase change material 25 when the heating element 10 generates heat and the phase change material 25 is heated. In FIG. 2A, the phase change material 25 is in a solid phase state from the time T0 to T1, and the temperature increases as the time passes. The phase change material 25 is in a state of phase transition from the solid phase to a liquid phase from the time T1 to T2, and the temperature during this time period is constant. At or after the time T2, the phase change material 25 is in a liquid phase state, and the temperature of the phase change material increases again as the time passes. FIG. 2B illustrates an example of a change of heat storage capability (W) of the phase change material 25. The change of heat storage capability corresponds to the change of the state of the phase change material 25 illustrated in FIG. 2A. The phase change material 25 stores latent heat which can be released by nucleating, from the time T1 at which the phase transition starts to the time T2 at which the phase transition ends. At or before the time T1 and at or after the time T2, sensible heat which contributes to a rise in the temperature of the phase change material 25 is stored. In the embodiment, a state before a time point when phase transition from a solid phase to a liquid phase ends is referred to as a “heat storable state”.

FIG. 2C illustrates an example of a temperature change of the phase change material 25 when the heating element 10 does not generate heat in a state that the phase change material 25 can not be supercooled, i.e., when the phase change material 25 is not heated. In FIG. 2C, the phase change material 25 is in the liquid phase state from the time T3 to T4, and the temperature lowers as the time passes. The phase change material 25 is in a state of phase transition from the liquid phase to a solid phase, from time T4 to T5, and the temperature is constant during the time period. At or after the time T5, the phase change material 25 is in the solid phase state, and the temperature of the phase change material 25 lowers again as the time passes. FIG. 2D illustrates an example of a temperature change of the phase change material 25 when the heating element 10 does not generate heat in a state that the phase change material 25 is in the supercooled state, that is, when the phase change material 25 is not heated. In FIG. 2D, the phase change material 25 is in the liquid phase state from the time T3 to T4, and the temperature lowers as the time passes. Further, at or after the time T4, the phase change material 25 does not either cause phase transition, and the temperature of the phase change material 25 lowers as the time passes while the liquid phase is maintained. At or after the time T4, the phase change material 25 is in a supercooled state.

FIG. 3 is a flowchart illustrating processing executed in the determination unit 41. The determination unit 41 can start processing at the same time as that of start of driving the electric vehicle, for example, and perform processing according to the following flow at a certain time interval during driving.

In step S1001, the second temperature of the medium is compared with a permissible temperature which is a predetermined temperature. The permissible temperature is an upper limit value of a temperature which is permissible for the medium and the heating element 10. The permissible temperature takes a value equal to or less than a boiling point temperature (100° C.) of the medium. Further, the permissible temperature is close to an upper temperature limit of the heating element 10. The permissible temperature takes a value lower than the upper temperature limit and can be determined in advance.

In step S1001, in a case where the second temperature is the permissible temperature or less, the flow goes to step S1002. In a case where the second temperature exceeds the permissible temperature, the flow goes to step S1103 as described in detail below. In step S1103, the control unit 42 switches the control valve 103 to “OFF” to divert the medium so as to flow through the bypass circuit, and turns the electric fan 32 “ON” forcibly. At this stage, the control valve 103 may be set “ON”.

In step S1002, a change amount d of the first temperature is calculated referring to a time history of the first temperature of the phase change material 25 stored in the storage device 300. The change amount d of the first temperature can be calculated by calculating a differential value of the time history of the first temperature or calculating a difference between values of the first temperature obtained at different times, for example. Further, the change amount d may be calculated by calculating an average value of differential values of the time history or differences between values of the first temperature in a certain time interval.

In step S1003, in a case where the change amount d of the first temperature of the phase change material 25 is higher than zero (d>0), it is determined that the phase change material 25 is in a “heated state.” A first control mode is selected, and the flow goes to step S1004. In a case where the change amount d of the first temperature is zero or less (d≦0), it is determined that the phase change material 25 in the “non-heated state.” A second control mode is selected, and the flow goes to step S1007.

In step S1004, the first temperature of the phase change material 25 is compared with a threshold A. The threshold A is a value which indicates a melting point of the phase change material 25. The value of the melting point may be obtained by an experiment in advance. The obtained value of the melting point can be stored as the threshold A in the storage device 300.

When the first temperature is the threshold A or less in step S1004, it is determined that the heat storage state of the phase change material 25 is a “heat storable state” and the determination result (heat storage flag=1) is stored in the storage device 300, in step S1005. When the first temperature is higher than the threshold A in step S1006, it is determined that the heat storage state is a “heat fully-stored state” and the determination result (heat storage flag=0) is stored in the storage device 300.

In step S1007, it is determined whether or not the phase change material 25 is in a supercooled state. In a case where the phase change material 25 is in the supercooled state in step S1008, the determination result that the latent heat storage state is the “supercooled state” (supercool flag=1) is stored in the storage device 300. In a case where the heat storage material 25 is not in the supercooled state in step S1009, the determination result that the heat storage state is the “non-supercooled state” (supercool flag=0) is stored in the storage device 300.

In step S1007, an estimation value of heat storage amount is calculated referring to a time history of the first temperature of the phase change material 25, for example. It is possible to compare the estimation value of heat storage amount with an experimental value of heat storage amount and to determine that the phase change material 25 is in a supercooled state when the estimation value is equal to the experimental value or more. The experimental value of heat storage amount is a value at which the phase change material 25 becomes in the supercooled state. The value is obtained by an experiment in advance.

FIGS. 4 and 5 are flowcharts illustrating processing executed by the control unit 42. FIG. 4 is the flowchart in a case where the first control mode is selected in FIG. 3.

The control unit 42 can start processing at the same time as that of starting driving the electric vehicle, for example, and can perform processing according to the following flow at a certain time interval during driving.

In step S1101, the heat storage state of the phase change material 25 is checked. When the state is a heat storable state (heat storage flag=1), the flow goes to step S1102. When the state is a heat fully-stored state (heat storage flag=0), the flow goes to step S1103.

In step S1102, the control unit 42 switches the control valve 103 to “ON”, and stores heat of the medium in the phase change material 25. The electric fan is turned “OFF”.

In step S1103, the control unit 42 switches the control valve 103 to “OFF”, and diverts the medium. Further, the electric fan 32 is turned “ON.” The second temperature of the medium is compared with a target temperature, and the number of times of rotation of the electric fan 32 is controlled to adjust the second temperature to be close to a target temperature. Algorithms such as P control, PI control or PID control can be used to control the number of times of rotation of the electric fan 32. The storage device 300 may store a table which relates a difference between the second temperature and a target value to the number of times of rotation of the electric fan 32, in advance, and the control unit 42 can control the number of times of rotation of the electric fan 32 referring to the table.

According to the first control mode, while the phase change material 25 is in the heat storable state, the phase change material 25 stores heat of the medium so that it is possible to cool the heating element 10. At the time, the electric fan 32 is “OFF” so that it is possible to reduce a consumption amount of energy i.e. power for operating or rotating the electric fan 32. The phase change material 25 stores heat of the medium so that it is possible to reduce the total amount of energy consumed in cooling the heating element 10.

When the phase change material 25 is in a heat fully-stored state, the heating element 10 can be cooled through release of heat from the radiator 31 with relatively highly cooling performance which is provided using the electric fan 32 in combination, even if the second temperature of the medium is a high temperature. When the second temperature of the medium is a relatively low temperature, the number of times of rotation of the electric fan 32 is controlled so as to be low so that it is possible to suppress a consumption amount of energy for operating or rotating the electric fan 32 to become small comparatively.

FIG. 5 is a flowchart in a case where the second control mode is selected in FIG. 3.

In step S1201, the heat storage state of the phase change material 25 is checked. When, the heat storage state is a supercooled state (supercool flag=1), the flow goes to step S1202, and, when the heat storage state is a non-supercooled state (supercool flag=0), the flow goes to step S1203.

In step S1202, the control unit 42 switches the control valve 103 to “ON.” By the switching, the medium is diverted, and the electric fan 32 is turned “ON.” In step S1202, the nucleating device 150 is turned “ON” to nucleate the phase change material 25 in the supercooled state. Heat of the phase change material 25 is given to the medium and is released from the radiator 31 to the outside of the cooling apparatus 1000.

In step S1203, the first temperature of the phase change material 25 is compared with a threshold B. The threshold B is a value which is set in advance as a temperature lower than a melting point of the phase change material 25. The threshold B is a threshold for determining whether or not the temperature of the phase change material 25 lowers sufficiently after the phase change material 25 releases heat by nucleating.

In step S1203, while the first temperature of the phase change material 25 exceeds the threshold B, the second control mode is maintained. Further, while the first temperature of the phase change material 25 is equal to the threshold B or less, the control mode is switched to the first control mode.

According to the second control mode, the phase change material 25 in a supercooled state is nucleated to release latent heat at a time point when operation of the heating element 10 is started. By releasing the latent heat, it is possible to place the phase change material 25 in a heat storable state and to switch to the first control mode.

When the heating element 10 is a battery, for example, the above processing performed by the determination unit 41 and the control unit 42 is started at timing when the heating element 10 is connected to an external power source such as a charging stand and is started to be charged. The processing may be sequentially performed during charging. Further, the above processing can be finished at timing when driving of the electric vehicle is finished, for example.

In step S1102, the control unit 42 desirably turns the electric fan 32 “OFF”, but the control unit 42 may control the number of times of rotation of the electric fan 32 according to the same method as that in step S1103. Even in this case, the heat storage tank 20 is used in combination as another cooling source so that the number of rotations of the electric fan 32 is small. As a result, it is possible to reduce consumption amount of energy.

The cooling apparatus 1000 according to the embodiment has the first control mode which uses the phase change material 25 as a cooling source. Thus, it is possible to reduce the total amount of energy which is consumed during cooling the heating element 10, compared with cooling which is performed using the electric fan 32 only. Further, it is possible to adjust timing to store heat in the phase change material 25 and to release heat from the phase change material 25 arbitrarily by using the phase change material 25 which can be in a supercooled state as a cooling source.

FIG. 6 is a block diagram illustrating a cooling apparatus 2000 according to a second embodiment.

The cooling apparatus 2000 has two heat storage tanks 20. Control valves 104 are provided in an upstream of the heat storage tanks 20 respectively. Each control valve 104 is controlled by a control unit 42 to switch a flow path of a medium to each corresponding heat storage tank 20 to “ON (pass)” or “OFF (block).” A determination unit 41 determines whether or not a phase change material 25 of each heat storage tank 20 can store heat. In this case, a heat storage state of each phase change material 25 for which determination is made is stored in a storage device 300. Processing which is executed in the determination unit 41 is the same as that in the first embodiment.

FIG. 7 is a flowchart illustrating processing which is executed in the determination unit 41 shown in FIG. 6. FIGS. 8 and 9 are flowcharts illustrating processing which is executed by the control unit 42.

In step S2001 of FIG. 7, the determination unit 41 checks whether or not heat storage flags are set for all of the phase change materials 25. When the heat storage flags are not set for all of the phase change materials 25, the flow returns to step S1004, and the temperature of the phase change material 25 for which any heat storage flag is not set is compared with a threshold A.

In step S2002, the determination unit 41 checks whether or not supercool flags are set for all of the phase change materials 25. When the supercool flags are not set for all of the phase change materials 25, the flow returns to step S1007, and the determination unit 41 checks whether or not the phase change material 25 for which the supercool flag is not set is in a supercooled state is checked.

In step S2101 in FIG. 8, it is checked whether or not any one of the phase change materials 25 of the heat storage tanks 20 can store heat. When a heat storage flag of at least one phase change material 25 is set to “1”, the flow goes to step S1102, and, when the heat storage flags of all of the phase change materials 25 are set to “0”, the flow goes to step S1103.

In step S1102, the control unit 42 switches a control valve 103 to “ON” and refers to the storage device 300. By the switching and referring, the control unit 42 controls one of the control valves 104 in the upstream of the corresponding heat storage tank 20 which includes the phase change material 25 determined to be in a heat storable state, so as to switch the one of the control valves 104 to “ON”. Further, the control unit 42 controls the other of the control valves 104, and switches the corresponding control valve 104 to “OFF”. When the plurality of the phase change materials 25 are in a heat storage states, one of the control valves 104 is switched to “ON”. In this case, it is possible to assign a priority to each heat storage tank 20 in advance and to perform switching according to the priority.

In step S2201 of FIG. 9, the determination unit 41 checks whether or not one of the phase change materials 25 of the heat storage tanks 20 is in a supercooled state. When a supercool flag of at least one of the phase change material 25 is set to “1”, the flow goes to step S1202 of FIG. 9 and, when the supercool flags of all of the phase change materials 25 are set to “0”, the flow goes to S2203.

In step S1202 of FIG. 9, the control unit 42 switches the control valve 103 to “ON” and refers to the storage device 300. By the switching and referring, the control unit 42 controls one of the control valves 104 in the upstream of the corresponding heat storage tank 20 which includes the phase change material 25 which is determined to be in a supercooled state, so as to switch the one of the control valves 104 to “ON”. Further, the control unit 42 controls the other of the control valves 104 to switch to “OFF”. A nucleating device 150 of the one of the heat storage tanks 20 which includes the phase change material 25 which is determined to be in a supercooled state is turned “ON.” Accordingly, the phase change material 25 in the supercooled state is nucleated, and heat of the phase change material 25 is released. In this case, when the plurality of the phase change materials 25 are in a supercooled state, any one of the control valves 104 is switched to “ON”. It is possible to assign a priority to each heat storage tank 20 in advance and to perform switching according to the priority.

In step S1202, when the plurality of the phase change materials 25 are in the supercooled state, all of the phase change materials 25 in the supercooled state may be sequentially nucleated. Further, when the second temperature of the medium is equal to a permissible temperature or less, the phase change materials 25 may be sequentially nucleated, and, when the second temperature exceeds the permissible temperature, even if any phase change material 25 in the supercooled state is left, the first control mode may be selected.

In step S2203, the determination unit 41 selects the first control mode when the first temperatures of all of the phase change materials 25 are a threshold B or less. The determination unit 41 maintains the second control mode when the first temperature of any one of the phase change materials 25 exceeds the threshold B.

The cooling apparatus 2000 according to the embodiment is provided with the plurality of the phase change materials 25, and consequently can enhance cooling performance by phase change material. When any one of the phase change materials 25 is in a heat storable state, the embodiment can select the first control mode whose energy consumption amount is relatively small. Thus, it is possible to increase a time period for keeping the first control mode. As a result, it is possible to reduce the consumption amount of energy of the cooling apparatus 2000 further.

The cooling apparatus or the cooling method according to the above embodiments can reduce the amount of energy consumed during cooling of a heating element.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A cooling apparatus comprising:
a circulation circuit which is closed to circulate a medium in a direction;
a heat exchanger provided at portion of the circulation circuit to provide heat released from a heating element to the medium;
a cooling unit provided at portion of the circulation circuit to cool the medium;
a heat storage tank arranged at a portion of the circulation circuit and between the heat exchanger and the cooling unit, the heat storage tank including a phase change material to receive heat from the medium flowing through the circulation circuit;
a bypass circuit which is connected to the circulation circuit at a first branch point between the heat exchanger and the heat storage tank and at a second branch point between the heat storage tank and the cooling unit;
a control valve which is capable of switching a flow of the medium to one of the heat storage tank or the bypass circuit;
a measurement unit which measures a temperature of the phase change material;
a determination unit which uses the measured temperature and determines whether or not the phase change material is in a heat storable state; and
a control unit which controls the control valve to switch the flow of the medium from the bypass circuit to the heat storage tank while the phase change material is in the heat storable state.

2. The apparatus according to claim 1, wherein the control unit controls the control valve to switch the flow of the medium from the heat storage tank to the bypass circuit while the phase change material is in a heat non-storable state.

3. The apparatus according to claim 2, further comprising a nucleating device which nucleates the phase change material in a supercooled state, wherein
the determination unit further determines whether or not the phase change material is in a supercooled state, and
the control unit switches the flow of the medium from the bypass circuit to the heat storage tank and operates the nucleating device when it is determined that the phase change material is in a supercooled state.

4. The apparatus according to claim 1, further comprising an air flow generation unit which generates an air flow toward the cooling unit, wherein the control unit drives the air flow generation unit while the flow of the medium is switched to the bypass circuit.

5. The apparatus according to claim 1, wherein the phase change material stores the heat in a case where the determination unit determines that the phase change material is in a heat storable state.

6. The apparatus according to claim 1, wherein the control valve is turned off, the medium is diverted so as to flow through the bypass circuit and the cooling unit cools the medium, while the temperature of the medium is a predetermined temperature or less.

7. The apparatus according to claim 3, wherein the phase change material stores heat of the medium through the control valve, while the temperature of the phase change material is a threshold or less.

8. The apparatus according to claim 1, further comprising first and second control valves, wherein the heat storage tank has first and second heat storage tanks and the first and second control valves control supply of the medium to the first and second heat storage tanks respectively by control of the control unit.

9. A cooling method using an apparatus which includes a circulation circuit, a heat exchanger, a cooling unit, a heat storage tank and a heat storage tank, the circulation circuit being closed to circulate a medium in a direction, the heat exchanger being provided at portion of the circulation circuit to provide heat released from a heating element to the medium, the cooling unit being provided at portion of the circulation circuit to cool the medium, the heat storage tank being arranged at a portion of the circulation circuit and between the heat exchanger and the cooling unit and including a phase change material to receive heat from the medium flowing through the circulation circuit, the determination unit determining whether or not the phase change material is in a heat storable state,
the cooling method comprising storing heat in the phase change material in a case where the determination unit determines that the phase change material is in a heat storable state.

10. A cooling apparatus for being installed on a vehicle which is provided with a motor, a battery and an inverter for inverting power from the battery to supply the inverted power to the motor, comprising:
a circulation circuit which is closed to circulate a medium in a direction;
a heat exchanger provided at a portion of the circulation circuit to give heat released from any one of the motor, the battery and the inverter to the medium;
a radiator provided at a front of the vehicle and at a portion of the circulation circuit to cools the medium;
a heat storage tank provided at a portion of the circulation circuit and between the heat exchanger and the radiator, the heat storage tank including a phase change material which receives heat from the medium which passes through the circulation circuit;
a bypass circuit which is connected to the circulation circuit at a first branch point between the heat exchanger and the heat storage tank and a second branch point between the heat storage tank and the radiator;
a control valve which is capable of switching a flow of the medium to one of the heat storage tank and the bypass circuit;
a measurement unit which measures a temperature of the phase change material;
a determination unit which determines whether or not the phase change material is in a heat storable state by using the measured temperature; and
a control unit which controls the control valve to switch the flow of the medium from the bypass circuit to the heat storage tank while the phase change material is in a heat storable state.

11. The apparatus according to claim 10, wherein the control unit controls the control valve to switch the flow of the medium from the heat storage tank to the bypass circuit while the phase change material is in a heat non-storable state.

12. The apparatus according to claim 10, further comprising a nucleating device which nucleates the phase change material in a supercooled state, wherein
the determination unit further determines whether or not the phase change material is in a supercooled state, and
the control unit switches the flow of the medium from the bypass circuit to the heat storage tank and operates the nucleating device when it is determined that the phase change material is in a supercooled state.

13. The apparatus according to claim 10, further comprising an air flow generation unit which generates an air flow toward the cooling unit, wherein the control unit drives the air flow generation unit while the flow of the medium is switched to the bypass circuit.

14. The apparatus according to claim 10, wherein the phase change material stores the heat in a case where the determination unit determines that the phase change material is in a heat storable state.

15. The apparatus according to claim 10, wherein the control valve is turned off, the medium is diverted so as to flow through the bypass circuit and the cooling unit cools the medium, while the temperature of the medium is a predetermined temperature or less.

16. The apparatus according to claim 12, wherein the phase change material stores heat of the medium through the control valve, while the temperature of the phase change material is a threshold or less.

17. The apparatus according to claim 10, further comprising first and second control valves, wherein the heat storage tank has first and second heat storage tanks and the first and second control valves control supply of the medium to the first and second heat storage tanks respectively by control of the control unit.
